(19) United States
(12) Patent Application Publication
(10) Pub. No.: US 2026/0336042 A1
(43) Pub. Date: Oct. 29, 2026

(54) WORKPIECE ROTATION DEVICE AND WORKPIECE SUPPORT DEVICE FOR WORKPIECE ROTATION DEVICE

(71) Applicant: Kabushiki Kaisha Kobe Seiko Sho (Kobe Steel, Ltd.), Kobe-shi (JP)

(72) Inventor: Motoaki MURAKAMI, Fujisawa-shi (JP)

(73) Assignee: Kabushiki Kaisha Kobe Seiko Sho (Kobe Steel, Ltd.), Kobe-shi (JP)

(21) Appl. No.: 19/145,965

(22) PCT Filed: Feb. 2, 2024
(86) PCT No.: PCT/JP2024/003533

§ 371 Date: Jul. 7, 2025

(30) Foreign Application Priority Data
Mar. 29, 2023 (JP) 2023-053375

(51) Int. Cl. B23K 37/047

(52) U.S. Cl. CPC B23K 37/047

(57) ABSTRACT

A workpiece support device that is used in a workpiece rotation device having a pair of positioners that rotatably hold the ends of a long workpiece, the workpiece support device supporting the workpiece from below. The workpiece support device comprises a pair of lifting mechanisms, a frame that is capable of moving along the workpiece, and a workpiece-receiving part that supports the lower surface of the workpiece. The lifting mechanisms each include: an elevating/lowering operation part in which an operation part moves vertically; a control unit that controls the elevating/lowering operation part; a moving pulley part that is pivotally supported at the distal end of the operation part of the elevating/lowering operation part; and a rope-like body that is wound around the moving pulley part, one end side of the rope-like body being connected to a movable part on the workpiece-receiving-part side, and the other end side of the rope-like body being fixed to a fixing part.

### TECHNICAL FIELD

The present invention relates a workpiece rotation device that rotatably holds a long workpiece in a longitudinal direction about a rotational axis, and a workpiece support device for the workpiece rotation device, the workpiece support device being configured to support, from below, the workpiece which is rotated by the workpiece rotation device.

### BACKGROUND ART

In general, in a welding system that welds a long workpiece by a welding robot, in order to arrange the welding position of the workpiece in the movable range of the welding robot, a workpiece rotation device is used which pivotably holds both end sides of the long workpiece extending in a horizontal direction.

As a conventional workpiece rotation device, PTL 1 discloses a workpiece rotation device including: a first rotary positioner that pivotably holds one end side of a workpiece; a second rotary positioner that pivotably holds the other end side of the workpiece; and a rail that slidably supports the first rotary positioner and the second rotary positioner.

### CITATION LIST

### Patent Literature

PTL 1: Japanese Unexamined Patent Application Publication No. 2020-189318

### SUMMARY OF INVENTION

### Technical Problem

The workpiece rotation device described in PTL 1 is intended to improve the efficiency of welding work by smoothly arranging the welding position of a long workpiece in the movable range of a welding robot. However, since the workpiece rotation device holds both end sides of the long workpiece, a problem arises in that downward deflection of the held workpiece may occur due to the self-weight, and the position of welding by a welding robot may be displaced. Similarly, depending on the weight and length of the workpiece, the workpiece may fall off from the positioners when an external force is exerted due to e.g., collision with the robot. As a countermeasure to cope with this, a workpiece support device that supports the workpiece from below may be used between the first rotary positioner and the second rotary positioner. When a workpiece support device is used, in general, a height positioning control method is applied according to the cross-sectional area size of the workpiece; however, this method needs a high-rigidity drive system such as a servo motor and a feed screw, resulting in a complicated configuration of apparatus, thus the cost is increased. In addition, the apparatus itself also increases in size, thus there is a risk of interference with another apparatus such as a welding robot.

The present invention has been made in consideration of the above-mentioned situation, and it is an object of the invention to provide a workpiece rotation device, and a workpiece support device for the workpiece rotation device, the workpiece rotation device being configured to rotatably hold a long workpiece about a rotational axis in a longitudinal direction, the workpiece support device supporting the workpiece from below and being configured to be simple and compact.

### Solution to Problem

The above-mentioned object of the present invention is achieved by the following configuration.

[1] A workpiece support device used in a workpiece rotation device that rotates a long workpiece about a rotational axis by a pair of positioners that rotatably hold ends of the workpiece about a rotational axis in a longitudinal direction of the workpiece, the workpiece support device supporting a longitudinal middle part of
the workpiece from below,
the workpiece support device comprising:
a pair of lifting mechanisms;
a mounting base on which the pair of lifting mechanisms are placed, the mounting base being capable of moving in the longitudinal direction of the workpiece; and
a workpiece-receiving part provided to bridge between the pair of lifting mechanisms and configured to support a lower surface of the workpiece,
wherein the lifting mechanisms each include:
a lifting/lowering operation part in which an operation part moves vertically;
a control unit that controls an operating force of the lifting/lowering operation part;

a moving pulley part that is pivotally supported by a distal end of an operation part of the lifting/lowering operation part; and
a rope-like body that is wound around the moving pulley part, one end side of the rope-like body being connected to a movable part on the workpiece-receiving-part side, and the other end side of the rope-like body being fixed to a fixing part.

[2] The workpiece support device for a workpiece rotation device, according to [1],
wherein the lifting/lowering operation part is an air cylinder having a lock function,
the distal end of the operation part is a rod distal end of an operation rod of the air cylinder, and
the control unit controls an operation of the air cylinder through a pressure regulating valve.

[3] The workpiece support device for a workpiece rotation device, according to [1],
wherein the mounting base is connected to a moving end of a cable carrier which is laid in a movement direction of the mounting base

[4] The workpiece support device for a workpiece rotation device, according to [2], further comprising
a storage unit that pre-stores a relationship between information on the workpiece and self-weight deflection of the workpiece,
wherein the control unit controls a pressure of the air cylinder based on information obtained from the storage unit, indicating the relationship between the information on the workpiece and the self-weight deflection of the workpiece.

[5] The workpiece support device for a workpiece rotation device, according to [4], further comprising:
a displacement sensor that detects a lifting position of the movable part; and
a rotation sensor that detects a rotation position of the positioners,
wherein the control unit calculates a target height of the workpiece-receiving part based on the rotation position of the workpiece obtained by the rotation sensor, and controls the pressure of the air cylinder based on the displacement sensor so that the workpiece-receiving part reaches the target height.

[6] A workpiece rotation device comprising:
positioners that hold both end sides of a long workpiece, and rotate the workpiece about a rotational axis in a longitudinal direction; and one or a plurality of workpiece support devices that support a longitudinal middle part of the workpiece from below,
wherein the workpiece support devices each include:
a pair of lifting mechanisms;
a mounting base that movably supports the pair of lifting mechanisms in the longitudinal direction of the workpiece; and
a workpiece-receiving part provided to bridge between the pair of lifting mechanisms, and
the lifting mechanisms each include:
a lifting/lowering operation part in which an operation part moves vertically ;
a control unit that controls an operating force of the lifting/lowering operation part;
a moving pulley part that is pivotally supported by a distal end of an operation part of the lifting/lowering operation part; and
a rope-like body that is wound around the moving pulley part, one end side of the rope-like body being connected to the workpiece-receiving-part side, and the other end side of the rope-like body being fixed to a fixing part.

[7] The workpiece rotation device according to [6], further comprising:
a control unit that controls the positioners; and
a laser sensor that detects a distance to the workpiece support device,
wherein the workpiece support devices are provided with a reflection part that reflects a laser emitted from the laser sensor.

### Advantageous Effects of Invention

According to the present invention, the workpiece-receiving part that supports the long workpiece from below is connected to the distal end of the operation part of the lifting/lowering operation part via the moving pulley, thus the lifting/lowering amount of the workpiece-receiving part is increased with respect to the lifting/lowering amount of the operation part of the lifting/lowering operation part. Therefore, the stroke length of the distal end of the operation part of the lifting/lowering operation part can be shortened, thus the entire workpiece support device can be made simple and compact, thereby making it possible to implement a low cost and prevention of interference with another apparatus such as a welding robot.

### BRIEF DESCRIPTION OF DRAWINGS

FIG. 1 is a side view illustrating a workpiece rotation device according to the present invention.

FIG. 2 is a front perspective view of a workpiece support device.

FIG. 3 is a rear perspective view of the workpiece support device.

FIG. 4 is a view illustrating a lifting mechanism.

FIG. 5 is a key front view illustrating a support device detector.

### DESCRIPTION OF EMBODIMENTS

Hereinafter, the configuration of a workpiece rotation device to which the present invention is applied will be described with reference to the accompanying drawings. Note that the drawings are made to explain the present invention, and the embodiment of the present invention is not limited to the content illustrated.

### Entire Configuration

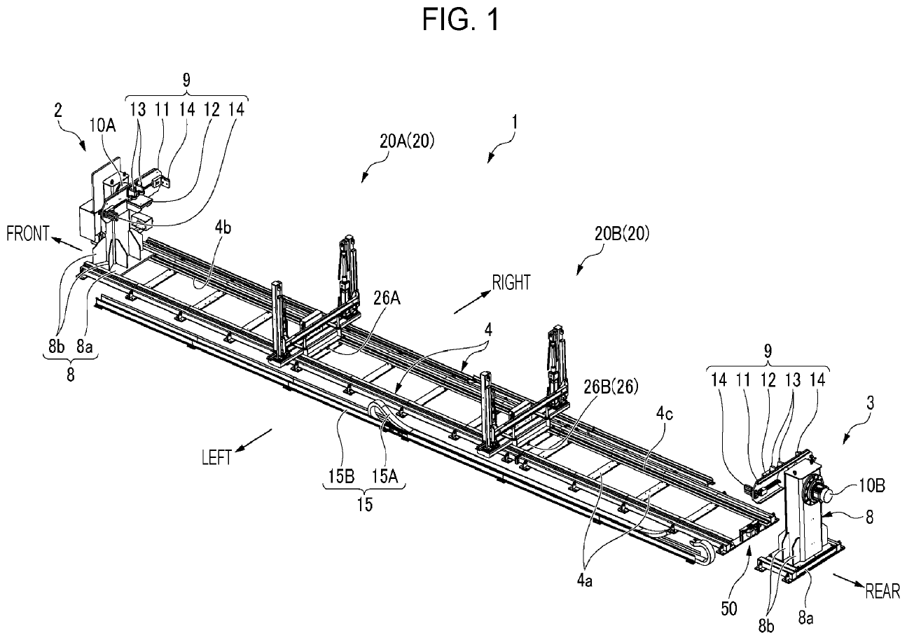

First, the entire configuration of a workpiece rotation device to which the present invention is applied will be described based on FIG. 1. FIG. 1 is a side view illustrating the workpiece rotation device according to the present invention.

The workpiece rotation device 1 includes a first rotary positioner 2, a second rotary positioner 3, a rail 4, a workpiece support device 20, and a support device detector 50. The first rotary positioner 2 and the second rotary positioner 3 rotatably hold both right and left end sides of a long workpiece which is not illustrated. The rail 4 is laid along the long workpiece supported by the first rotary positioner 2 and the second rotary positioner 3. One or more workpiece support devices 20 are disposed on the rail 4 to support a longitudinal middle part of the workpiece from below. The support device detector 50 detects the position of the workpiece support device 20 which is movable along the rail 4.

Note that in the example illustrated, two workpiece support devices 20 are disposed on the rail 4. Let a first workpiece support device 20A be the one closer to the first rotary positioner 2, and let a second workpiece support device 20B be the one closer to the second rotary positioner 3.

In the embodiment below, the direction in which the rail extends is referred to as the front-rear direction. For the sake of convenience, particularly, the direction to the first rotary positioner 2 is referred to as the forward direction, and the opposite direction to the front-rear direction is referred to as the rearward direction. The crossing direction perpendicular to the extending direction of a pair of rails is referred to as the right-left direction.

The first rotary positioner 2 has a support part 8, a holder part 9, and a bearing part 10A. Similarly, the second rotary positioner 3 has the support part 8, the holder part 9, and a drive part 10B.

The support part 8 is a vertical columnar member that moves along the rails 4. The holder part 9 rotatably holds one end of the workpiece at an upper portion of the support part 8. The drive part 10B of the second rotary positioner 3 rotationally drives the holder part 9. The bearing part 10A of the first rotary positioner 2 is rotated by the driving force of the drive part 10B transmitted through a workpiece (not illustrated) supported by the workpiece rotation device 1.

On the lower end side of the support part 8, a support stand 8a slidably inserted in the rail 4 is provided. On the peripheral surface on the lower end side of the support part 8, multiple ribs 8b comprised of vertical plate-like members are provided side by side. The holder part 9 is rotatably pivotally supported at an upper portion of the support part 8.

The holder part 9 is provided with a holding plate 11, web holding bodies 12, 13, and flange holding bodies 14, 14.

The holding plate 11 is a rectangular plate-like member provided at an upper portion of the support part 8, and its central part is rotatably pivotally supported by the bearing part 10A and the drive part 10B.

The web holding bodies 12, 13 have a plate-like first web holding body 12 that supports an H-shaped steel web from below, and a pair of second web holding bodies 13, 13 between which the H-shaped steel web placed on the first web holding body 12 is interposed in a plate thickness direction. The first web holding body 12 and the second web holding bodies 13 are disposed side by side at a longitudinal center of the holding plate 11 in a transverse direction of the holding plate 11. The space between the first web holding body 12 and the second web holding bodies 13 is configured to be adjustable. In other words, the web holding bodies 12, 13 can insert an H-shaped steel web as a long workpiece between themselves.

The flange holding bodies 14, 14 are a pair of plate-like members disposed at both end sides of the holding plate 11 in the longitudinal direction. The pair of flange holding bodies 14, 14 are configured to adjustable in position in the longitudinal direction of the holding plate 11. Specifically, the flange holding bodies 14, 14 can insert the upper flange and the lower flange of an H-shaped steel between themselves by adjusting the space between the pair of flange holding bodies 14, 14 according to the workpiece to be held.

Thus, the holder part 9 can stably hold the ends of an H-shaped steel in various sizes and types.

Note that the holder part 9 can hold the ends when the shape of the ends of the workpiece has a cross section which allows insertion by the web holding bodies 12, 13 or the flange holding bodies 14, 14. The workpiece holdable by the holder part 9 is not limited to long H-shaped steel.

The rails 4 are laid as a pair along a long workpiece. Each rail 4 has a reinforcing member 4a, a guide groove 4b, and a support device rail part 4c. The reinforcing member 4a is a railroad tie-shaped member provided to bridge between the pair of rails 4, 4. Multiple reinforcing member 4a are disposed side by side with a predetermined interval in the extending direction of the rails 4.

The guide grooves 4b, 4b are formed in the opposing surfaces of the pair of rails 4, 4. Insertion of both right and left sides of the support stand 8a into the pair of guide grooves 4b, 4b allows the first rotary positioner 2 and the second rotary positioner 3 to be moved along the rails 4.

The support device rail part 4c is an upward projecting part which extends along the rails 4 on the right and left inner sides of the pair of rails 4, 4. Placement of the workpiece support device 20 on the support device rail parts 4c, 4c allows the workpiece support device 20 to be movably supported along the rails 4.

On one of right and left sides of the rails 4, a cable carrier 15 extending along the rails 4 is provided. The cable carrier 15 has a belt-shaped housing body 15A that houses and protects a cable connected to the workpiece support device 20, and a U-shaped guide part 15B extending along the rails 4 and having an upward opening to guide the housing body 15A. See FIG. 1 for this configuration. The ends of the housing body 15A are connected to a mounting base 21 side which moves along the rails 4.

Thus, even when the mounting base 21, to which the ends of the cable extending along the rails 4 are connected, moves along the rails 4, the housing body 15A housing the cable is smoothly guided into the guide part 15B.

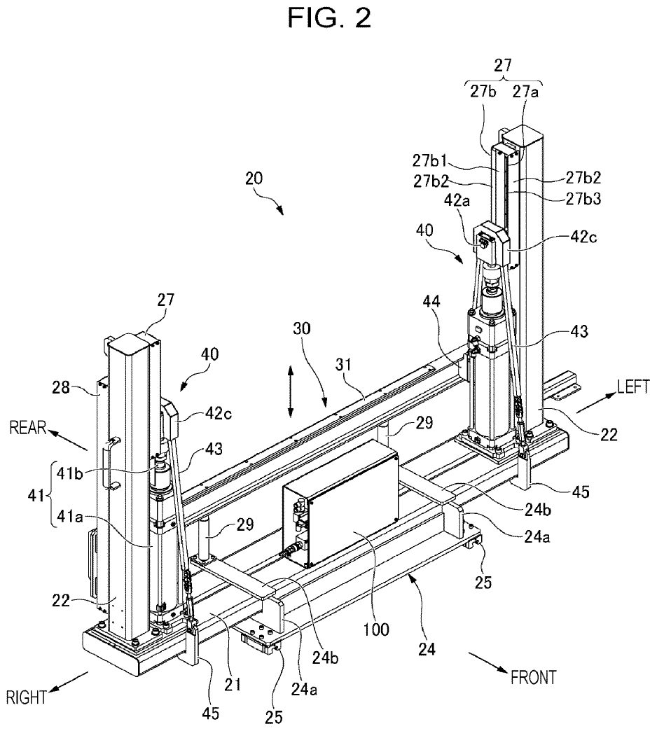

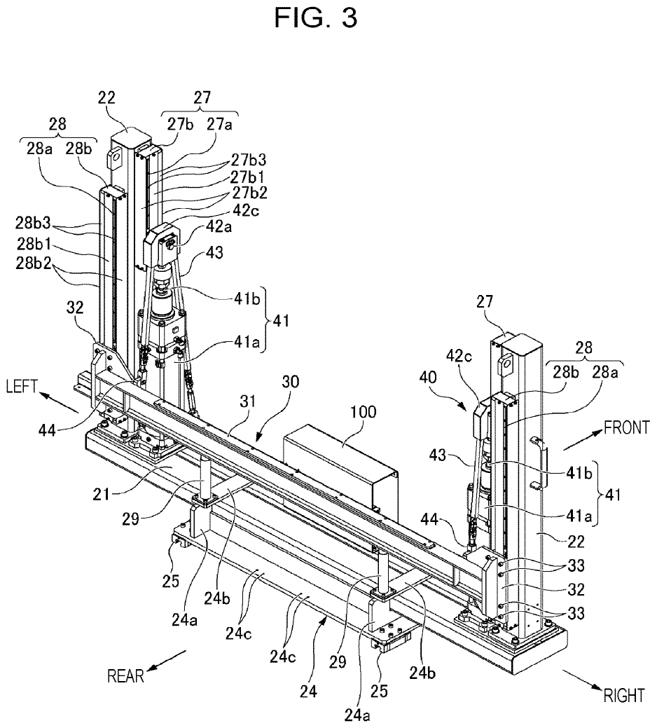

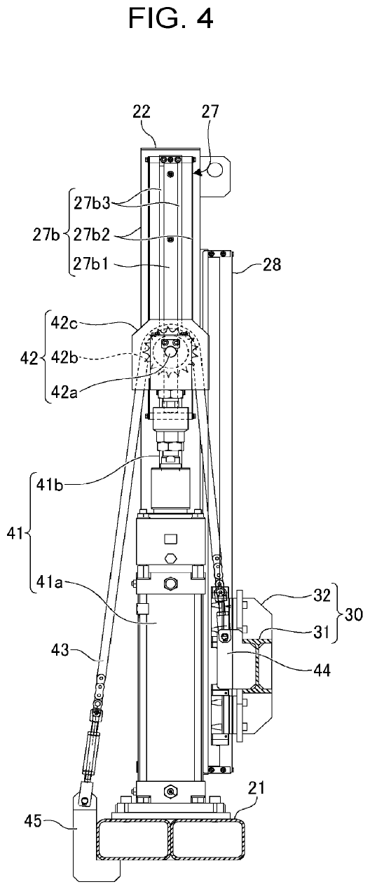

Next, the workpiece support device 20 will be described based on FIG. 1 to FIG. 4. FIG. 2 and FIG. 3 are a front perspective view and a rear perspective view of the workpiece support device, and FIG. 4 is a view illustrating a lifting mechanism. The workpiece support device 20 includes the mounting base 21, a pair of guide bodies 22, 22, a workpiece-receiving part 30, a pair of lifting mechanisms 40, 40, and a control unit 100.

The mounting base 21 is a plate-like member that extends in the right and left direction to bridge between the pair of rails 4, 4. The pair of guide bodies 22, 22 is a pair of vertical columnar members that extend upward from both right and left end sides of the mounting base 21. The workpiece-receiving part 30 is a plate-like member that extends in the right and left direction to bridge between the pair of guide bodies 22, 22, the plate-like member being liftably installed with the orientation perpendicular to the pair of guide bodies 22, 22 maintained. The pair of lifting mechanisms 40, 40 cause the workpiece-receiving part 30 to perform a lifting/lowering operation by air cylinders 41 provided in the guide bodies 22 22, respectively.

The mounting base 21 is movably guided along the extending direction of the rails 4 with the orientation perpendicular to the extending direction of the rails 4 maintained.

The guide bodies 22, 22 and the lifting mechanisms 40, 40 are provided on the upper side of both right and left ends of the mounting base 21. On the lower side of the horizontal center of the mounting base 21, a support plate 24, rail engagement parts 25, and a reflector 26 are provided.

The support plate 24 is a rectangular plate-like member supported on the lower side of the center of the mounting base 21 in the right-left direction. The support plate 24 extends in the right-left direction so as to bridge between the pair of support device rail parts 4c, 4c. The support plate 24 is formed to be larger than the mounting base 21 in the front-rear direction in a plan view.

A pair of support plates 24 are disposed on both right and left end sides, and connected to the mounting base 21 side by first connecting members 24a, 24a in the front-rear direction mounted to fit into the lower side of the mounting base 21, and second connecting members 24b, 24b in the front-rear direction each mounted to bridge between the upper end sides of the first connecting member 24a formed in a U shape. In short, the circumference of the mounting base 21 is surrounded by the first connecting members 24a, and the second connecting members 24b.

Note that on the rear end sides of the second connecting members 24b, a pair of vertical regulating pins 29, 29 that support the workpiece-receiving part 30 from below at a lower limit position are provided. See FIG. 2 and FIG. 3 for this configuration.

The rail engagement parts 25, 25, 25, 25, 25 are respectively provided at 4 corners, that is, the ends of the lower surface side of the support plate 24 in the front-rear direction and the right-left direction. The rail engagement parts 25, 25, 25, 25 are provided with respective grooves in the front-rear direction for guidably engaging with the support device rail parts 4c. See FIG. 2 and FIG. 3 for this configuration.

Thus, the space between the rail engagement parts 25, 25 arranged in the front-rear direction is formed to be larger than the front-rear width of the mounting base 21, thus the workpiece support device 20 can be stably supported on the rails 4.

Each reflector 26 is mounted and fixed to a mounting hole 24c formed on the upper surface side of the horizontal central side of the support plate 24. The reflector 26 includes a mirror (not illustrated) to reflect a laser.

Thus, the position on the rails 4 of the workpiece support device 20 provided with the reflector 26 can be detected by irradiating the reflector 26 with a laser emitted from a predetermined position.

The reflector 26 can be disposed in an empty space formed between the pair of rails 4, 4 in a front-rear view and on the lower side of the mounting base 21. Thus, the entire apparatus can be compactly constructed.

Also, two sets of mounting holes 24c are provided side by side in the right-left direction. Thus, a first reflector 26A mounted on the first workpiece support device 20A, and a second reflector 26B mounted on the second workpiece support device 20B can be offset in the right-left direction. See FIG. 1 and FIG. 3 for this configuration.

The guide body 22 has a lifting guide part 27, and a receiving guide part 28. The lifting guide parts 27, 27 are respectively provided on the opposing surfaces of the pair of guide bodies 22, 22. The receiving guide parts 28, 28 are respectively provided on the rear surface sides of the pair of guide bodies 22.

Each lifting guide part 27 has a linear rail 27a vertically extending along the guide body 22 on the upper half side of the guide body 22, and a rail housing part 27b that houses the linear rail 27a.

The rail housing part 27b has a rail cover 27b1 extending along the linear rail 27a and being disposed between the linear rail 27a and the air cylinder 41, and a pair of side covers 27b2, 27b2 that cover the lateral surfaces of the linear rail 27a in the front-rear direction. Between the rail cover 27b1 and the side cover 27b2, a pair of insertion grooves 27b3 along the linear rail 27a are formed. See FIG. 3 for this configuration.

Each receiving guide part 28 has a linear rail 28a vertically extending along the guide body 22 from the lower end side to the upper end side of the guide body 22, and a rail housing part 28b that houses the linear rail 28a.

The rail housing part 28b has a rail cover 28b1 extending along the linear rail 28a and being disposed between the linear rail 28a and the end side of the workpiece-receiving part 30, and a pair of side covers 28b2, 28b2 that cover the lateral surfaces of the linear rail 28a in the right-left direction. Between the rail cover 28b1 and the side cover 28b2, a pair of insertion grooves 28b3 along the linear rail 28a are formed. See FIG. 3 for this configuration.

The shape and material of the workpiece-receiving part 30 are not limited to specific ones, but in the present embodiment, the workpiece-receiving part 30 is shaped steel in H form (hereinafter, also referred to as H-shaped steel) extending in the right-left direction, and has a placement part 31, and a guided part 32.

The placement part 31 is the upper surface of the upper flange of H-shaped steel extending in the right-left direction, and is provided with a buffer material comprised of an elastic member that directly supports the workpiece from below.

The guided parts 32, 32 are a pair of plate-like members fixed to the front surface sides of both horizontal ends of the workpiece-receiving part 30. On the front surface side of the guided part 32, a linear guide (not illustrated) that slides along the linear rail 28a of the receiving guide part 28 is mounted and fixed. The linear guide is connected to the guided part 32 side through the pair of insertion grooves 28b3, 28b3 formed between the rail cover 28b1 and the side cover 28b2.

Specifically, the linear guides provided in the guided parts 32, 32 perform a lifting/lowering operation along the linear rails 28a, 28a provided in the receiving guide part 28. Thus, it is possible to cause the workpiece-receiving part 30 extending in the right-left direction to smoothly perform a lifting/lowering operation with the orientation maintained, which is approximately perpendicular to the vertical direction in which the pair of guide bodies 22, 22 extend.

Each lifting mechanism 40 includes an air cylinder 41, a moving pulley part 42, and a rope-like body 43. See FIGS. 2 to 4 for this configuration.

The air cylinder 41 has a cylinder part 41a, and a piston rod 41b.

The lower end side of the cylinder part 41a formed in a tubular shape in the vertical direction is firmly fixed with a screw to the upper surface side of the mounting base 21. The piston rod 41b is a vertical operation part that projects upward from the upper end of the cylinder part 41a.

The air cylinder 41 is a double-acting single rod cylinder, and has a lock function. In the air cylinder 41, 5 port electromagnetic valve is used as a pressure regulating control valve.

To the cylinder part 41a of the air cylinder 41, a connecting path is connected through the cable carrier 15, the connecting path for intaking and exhausting air to control an expansion and contraction operation of the piston rod 41b.

The moving pulley part 42 has a pivot support part 42a, a sprocket 42b, and a cover body 42c. The moving pulley part 42 is provided with a linear guide (not illustrated) between the lifting guide part 27 and itself, the linear guide being configured to slide along the linear rail 27a.

The pivot support part 42a is a rod-shaped member in the right-left direction, which is fixed to the distal end of the piston rod 41b, and performs a lifting/lowering operation integrally with the piston rod 41b.

The sprocket 42b is rotatably pivotally supported on the pivot support part 42a, and the rope-like body 43 comprised of a drive chain is wound around the sprocket 42b.

The cover body 42c is formed in a box shape with the bottom opened so as to house the sprocket 42b.

The linear guide is connected to the moving pulley part 42 side through the pair of insertion grooves 27b3, 28b3 formed between the rail cover 27b1 and the side cover 27b2. Specifically, the linear guide is fixed to the pivot support part 42a or the cover body 42c side.

Specifically, the linear guides provided in the moving pulley parts 42, 42 perform a lifting/lowering operation along the linear rails 27a, 27a provided in the lifting guide parts 27, 27. Thus, it is possible to cause the piston rod 41b of the air cylinder 41 to smoothly perform a lifting/lowering operation along the pair of guide bodies 22, 22.

The rope-like body 43 is a drive chain which can be wound around the sprocket 42b.

The end of the rope-like body 43 on one side is connected to a movable part 44 on the rear lower side of the sprocket 42b, the movable part 44 being provided on each of both right and left end sides of the workpiece-receiving part 30 side. In this configuration, the movable part 44 is a member provided to fit into the web on the front surface of the workpiece-receiving part 30 comprised of H-shaped steel, and is firmly fixed to the end side of the workpiece-receiving part 30. See FIG. 2 and FIG. 4 for this configuration.

The end of the rope-like body 43 on the other side is connected to a fixing part 45 on the front lower side of the sprocket 42b, the fixing part 45 being fixed to each of both right and left end sides of the mounting base 21. The fixing part 45 is an L-shaped member that is in contact with the lower surface and the lateral surface of the mounting base 21, and is firmly fixed to the mounting base 21 side. See FIG. 4 for this configuration.

Thus, when the sprocket 42b performs a lifting operation along with an extension operation of the piston rod 41b, the lifting mechanism 40 causes the workpiece-receiving part 30 connected to the movable part 44 to perform a lifting operation via the rope-like body 43 wound around the sprocket 42b. That is, in the lifting mechanism 40, due to the use of the moving pulley, the amount of elevation of the workpiece-receiving part 30 is approximately twice the amount of extension of the piston rod 41b.

Note that the moving pulley part 42 and the rope-like body 43 may be configured to operate in a similar manner, and without being limited to the above-mentioned configuration, for example, a pulley (not illustrated) may be used instead of the sprocket 42b, and a drive belt (not illustrated) may be used instead of the drive chain 43. In the lifting mechanism 40, instead of the configuration of the air cylinder 41, the moving pulley part 42, and the rope-like body 43, for example, double speed and double stroke mechanism consisting of a pair of drive motors, an output gear, and a pair of rack gears which are not illustrated may be adopted.

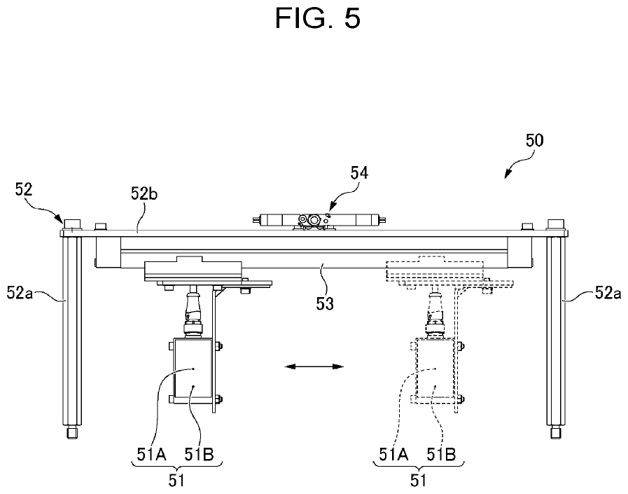

Next, the support device detector 50 will be described based on FIG. 5. FIG. 5 is a key front view illustrating the support device detector. The support device detector 50 is disposed between the pair of rails 4, 4, and is provided at one end side of the rails 4 in the extending direction, or the support stand 8a side of the first rotary positioner 2 or the second rotary positioner 3. In the example illustrated, the support device detector 50 is provided at the support stand 8a side of the second rotary positioner 3. See FIG. 1 and FIG. 5 for this configuration.

The support device detector 50 has a laser sensor 51, a support bracket 52 that horizontally movably suspends and supports the laser sensor 51, an actuator 53 that controls the horizontal position of the laser sensor 51 supported by the support bracket 52, and a solenoid valve 54 that controls the actuator 53.

The laser sensor 51 has a light projector 51A that emits a laser to the reflector 26 provided in the workpiece support device 20 side, and a light receiver 51B that receives a laser reflected from the reflector 26.

The support bracket 52 has a horizontal pair of support pillars 52a, 52a in the vertical direction, and a beam part 52b that connects the upper ends of the support pillars 52a, 52a. The beam part 52b is provided with an actuator 53 that suspends and supports the laser sensor 51 slidably along the beam part 52b. In the example illustrated, a rodless air cylinder is used as the actuator 53.

A rodless air cylinder 53 can control the horizontal position of the laser sensor 51 on the beam part 52b by the solenoid valve 54. The actuator 53 may be configured to operate the horizontal position of the laser sensor 51, and the actuator 53 is not limited to the rodless air cylinder 53.

The control unit 100 is housed in a housing box which is disposed on the upper surface front side of the horizontal center of the mounting base 21. The upper end side of the control unit 100 is disposed below the placement part 31 of the workpiece-receiving part 30 which has lowered to a lower limit position. As the control unit 100, a CPU, a GPU or a GPGPU or the like is used.

Thus, the control unit 100 can be arranged in an empty space formed on the upper surface of the mounting base 21 forward of the workpiece-receiving part 30 with a high efficiently.

The control unit 100 can control the expansion and contraction operation of the piston rod 41b, and switching to a fixed state by controlling the pressure regulating control valve (not illustrated) in the cylinder part 41a. At this point, it is possible to control the operating force when an extension operation of the piston rod 41b is performed.

### Operation and Effect

According to the above-described configuration, the workpiece support device 20 can control the lifting position of the workpiece-receiving part 30 by controlling the expansion and contraction operation of the air cylinder 41 with the control unit 100. When a workpiece is supported by the workpiece support device 20 from below, the support force with which the workpiece-receiving part 30 pushes back and supports the lower surface of the workpiece can also be adjusted.

Thus, the workpiece support device 20 can smoothly and efficiently support, from below, a longitudinal middle part of a long workpiece rotatably supported by the workpiece rotation device 1. Also, deflection of a long workpiece due to its self-weight can be prevented by supporting the workpiece with an appropriate support force from below.

The control unit 100 has a storage unit (not illustrated) that pre-stores, as a database, information on the workpiece such as the cross-sectional shape, cross-sectional size, weight, length, material of the workpiece, and information indicating a relationship between those factors and the self-weight deflection of the workpiece. The storage unit may refer to a RAM which is a volatile memory area, and a ROM and an HDD or the like which are non-volatile memory areas. Note that the storage unit may be built-in the control unit 100, or provided in a server connected via a network.

Thus, the workpiece support device 20 controls, based on the database, the position on the rails 4, at which the workpiece is supported from below by the workpiece support device 20, and the pressure of the air cylinder 41 which causes the workpiece-receiving part 30 to perform a lifting/lowering operation, thereby making it possible to support the workpiece from below so that the self-weight deflection is minimized.

Alternatively, in the workpiece support device 20, the workpiece-receiving part 30 or the movable part 44 may be separately provided with a displacement detection sensor (not illustrated) that detects the height position of the workpiece-receiving part 30.

Thus, the control unit 100 calculates a target height of the workpiece-receiving part 30 based on the information on the workpiece, and the rotation position of the workpiece, and can control the pressure of the air cylinder 41 so that the workpiece-receiving part 30 reaches the target height. In other words, the lifting position of the workpiece-receiving part 30 can be controlled with higher accuracy.

In addition, the lifting position of the workpiece-receiving part 30 that supports the workpiece from below can be firmly held because the air cylinder 41 having the lock function is used for the lifting mechanism 40. For example, even when the workpiece falls off from the first rotary positioner 2 and the second rotary positioner 3, the workpiece support device 20 can stably support the workpiece. In addition, the configuration of the workpiece support device 20 that supports the workpiece from below is simplified, and the manufacturing cost can also be kept low.

In the lifting mechanism 40, the double speed double stroke mechanism is constructed by the moving pulley part 42 and the rope-like body 43, thus the lifting/lowering amount of the workpiece-receiving part 30 can be increased with respect to the amount of extension of the air cylinder 41.

Consequently, the vertical width of the entire workpiece support device 20 can be made compact. Accordingly, the height of the rotational axis of the first rotary positioner 2 and the second rotary positioner 3 can also be kept low, thereby improving the workability. In addition, the upper end position of the workpiece support device 20 does not project much from the rotational axis of the first rotary positioner 2 and the second rotary positioner 3, thus the workpiece support device 20 is unlikely to interfere with the operation of a welding robot.

The support device detector 50 emits a laser forward from the laser sensor 51 which has been moved to the right side of the beam part 52b by the rodless air cylinder 53, and receives a laser reflected by the first reflector 26A attached to the first workpiece support device 20A, thereby making it possible to detect the accurate position of the first workpiece support device 20A on the rails 4. Similarly, the support device detector 50 emits a laser forward from the laser sensor 51 which has been moved to the left side of the beam part 52b by the rodless air cylinder 53, and receives a laser reflected by the second reflector 26B attached to the second workpiece support device 20B, thereby making it possible to detect the accurate position of the second workpiece support device 20B on the rails 4. See FIG. 1 and FIG. 5 for this configuration.

Thus, the entire support device detector 50 can be made simple and compact.

In addition, the support device detector 50 can accurately detect the positions of the first workpiece support device 20A and the second workpiece support device 20B on the rails 4, which support the long workpiece from below.

Note that the present invention is not limited to the above embodiment, and modifications, and applications made by those skilled in the art based on mutual combinations of the components of the embodiment, the description of the specification, and well-known techniques are contemplated by the present invention, and included in the range of protection of the present invention.

As described above, the following matters are disclosed in the present specification.

(1) A workpiece support device used in a workpiece rotation device that rotates a long workpiece about a rotational axis by a pair of positioners that rotatably hold ends of the workpiece about a rotational axis in a longitudinal direction of the workpiece, the workpiece support device supporting a longitudinal middle part of the workpiece from below,
the workpiece support device comprising:
a pair of lifting mechanisms;
a mounting base on which the pair of lifting mechanisms are placed, the mounting base being capable of moving in the longitudinal direction of the workpiece; and
a workpiece-receiving part provided to bridge between the pair of lifting mechanisms and configured to support a lower surface of the workpiece,
wherein the lifting mechanisms each include:
a lifting/lowering operation part in which an operation part moves vertically;
a control unit that controls an operating force of the lifting/lowering operation part;
a moving pulley part that is pivotally supported by a distal end of an operation part of the lifting/lowering operation part; and
a rope-like body that is wound around the moving pulley part, one end side of the rope-like body being connected to a movable part on the workpiece-receiving-part side, and the other end side of the rope-like body being fixed to a fixing part.

According to this configuration, the workpiece-receiving part that supports the long workpiece from below is connected to the distal end of the operation part of the lifting/lowering operation part via the moving pulley part, thus the lifting/lowering amount of the workpiece-receiving part is increased with respect to the lifting/lowering amount of the operation part of the lifting/lowering operation part. Consequently, the stroke length of the distal end of the operation part of the lifting/lowering operation part can be shortened, thus the entire workpiece support device can be made simple and compact.

(2) The workpiece support device for a workpiece rotation device, according to (1),
wherein the lifting/lowering operation part is an air cylinder having a lock function,
the distal end of the operation part is a rod distal end of an operation rod of the air cylinder, and
the control unit controls an operation of the air cylinder through a pressure regulating valve.

According to this configuration, by using an air cylinder as the lifting/lowering operation part, the workpiece-receiving part that supports the workpiece from below can be brought into contact with the workpiece by an appropriate force. In addition, by using an air cylinder having a lock function for locking a lifting/lowering operation, even when the workpiece-receiving part has a simple structure, a heavy workpiece can be stably supported.

(3) The workpiece support device for a workpiece rotation device, according to (1) or (2),
wherein the mounting base is connected to a moving end of a cable carrier which is laid in a movement direction of the mounting base.

According to this configuration, the workpiece support part connected to the cable carrier can be smoothly moved along the movement direction of the mounting base.

(4) The workpiece support device for a workpiece rotation device, according to (2) or (3), further comprising
a storage unit that pre-stores a relationship between information on the workpiece and self-weight deflection of the workpiece,
wherein the control unit controls a pressure of the air cylinder based on information obtained from the storage unit, indicating the relationship between the information on the workpiece and the self-weight deflection of the workpiece.

According to this configuration, the workpiece support part can support the workpiece from below in consideration of the self-weight deflection of the long workpiece. Therefore, the long workpiece can be held with higher accuracy.

(5) The workpiece support device for a workpiece rotation device, according to any one of (2) to (4), further comprising:
a displacement sensor that detects a lifting position of the movable part; and
a rotation sensor that detects a rotation position of the positioners,
wherein the control unit calculates a target height of the workpiece-receiving part based on the rotation position of the workpiece obtained by the rotation sensor, and controls the pressure of the air cylinder based on the displacement sensor so that the workpiece-receiving part reaches the target height.

According to this configuration, the lifting position of the workpiece-receiving part can be accurately detected, thus it is possible to support the long workpiece from below by the workpiece-receiving part with higher accuracy.

(6) A workpiece rotation device comprising:
positioners that hold both end sides of a long workpiece, and rotate the workpiece about a rotational axis in a longitudinal direction; and one or a plurality of workpiece support devices that support a longitudinal middle part of the workpiece from below,
wherein the workpiece support devices each include:
a pair of lifting mechanisms;
a mounting base that movably supports the pair of lifting mechanisms in the longitudinal direction of the workpiece; and
a workpiece-receiving part provided to bridge between the pair of lifting mechanisms, and
the lifting mechanisms each include:
a lifting/lowering operation part in which an operation part moves vertically;
a control unit that controls an operating force of the lifting/lowering operation part ;
a moving pulley part that is pivotally supported by a distal end of an operation part of the lifting/lowering operation part; and
a rope-like body that is wound around the moving pulley part, one end side of the rope-like body being connected to the workpiece-receiving-part side, and the other end side of the rope-like body being fixed to a fixing part.

According to this configuration, the workpiece-receiving part that supports the workpiece from below is connected to the distal end of the operation part of the lifting/lowering operation part via a double speed double stroke mechanism comprised of the moving pulley, thus the lifting/lowering amount of the workpiece-receiving part is increased with respect to the lifting/lowering amount of the operation part of the lifting/lowering operation part. Therefore, the stroke length of the distal end of the operation part of the lifting/lowering operation part can be shortened, thus the entire workpiece support device can be made simple and compact.

(7) The workpiece rotation device according to (6), further comprising:
a control unit that controls the positioners; and
a laser sensor that detects a distance to the workpiece support device,
wherein the workpiece support devices are provided with a reflection part that reflects a laser emitted from the laser sensor.

According to this configuration, the position at which the long workpiece is supported from below by the workpiece support device can be detected, thus supporting of the workpiece from below can be performed with high accuracy.

Although various embodiments have been described above with reference to the drawings, needless to say that the present invention is not limited to such examples. It is apparent that various modification examples and alteration examples will occur to those skilled in the art within the scope described in the appended claims, and it should be understood that those examples naturally fall within the technical scope of the present invention. In a range not departing from the spirit of the invention, the components in the above embodiments may be combined in any manner.

The present application is based on Japanese Patent Application (No. 2023-053375) filed on Mar. 29, 2023, the entire contents of which are incorporated herein by reference.

### REFERENCE SIGNS LIST

1 workpiece rotation device
2 first rotary positioner (positioner)
3 second rotary positioner (positioner)
4 rail
4a reinforcing member
4b guide groove
4c support device rail part
8 support part
8a support stand
8b rib
9 holder part
10A bearing part
10B drive part
11 holding plate
12 first web holding body (web holding body)
13 second web holding body (web holding body)
14 flange holding body
15 cable carrier
15A housing body
15B guide part
20 workpiece support device
20A first workpiece support device
20B second workpiece support device
21 mounting base
22 guide body
24 support plate
24a first connecting member
24b second connecting member
24c mounting hole
25 rail engagement part
26 reflectors (reflection part)
26A first reflector
26B second reflector
27 lifting guide part
27a linear rail
27b rail housing part
28 receiving guide part
28a linear rail
28b rail housing part
29 regulating pin
30 workpiece-receiving part
31 placement part
32 guided part
33 guide piece
40 lifting mechanism
41 air cylinder (lifting/lowering operation part)
41a cylinder part
41b piston rod (operation part, operation rod)
42 moving pulley part
42a pivot support part
42b sprocket
42c cover body
43 rope-like body, drive chain
44 movable part
45 fixing part
50 support device detector
51 laser sensor
51A light projector
51B light receiver
52 support bracket
52a support pillar
52b beam part
53 rodless air cylinder, actuator
54 solenoid valve
100 control unit

1. A workpiece support device used in a workpiece rotation device that rotates a long workpiece about a rotational axis by a pair of positioners that rotatably hold ends of the workpiece about a rotational axis in a longitudinal direction of the workpiece, the workpiece support device supporting a longitudinal middle part of the workpiece from below,
the workpiece support device comprising:
a pair of lifting mechanisms;
a mounting base on which the pair of lifting mechanisms are placed, the mounting base being capable of moving in the longitudinal direction of the workpiece; and
a workpiece-receiving part provided to bridge between the pair of lifting mechanisms and configured to support a lower surface of the workpiece,
wherein the lifting mechanisms each include:
a lifting/lowering operation part in which an operation part moves vertically ;
a control unit that controls an operating force of the lifting/lowering operation part;
a moving pulley part that is pivotally supported by a distal end of an operation part of the lifting/lowering operation part; and
a rope-like body that is wound around the moving pulley part, one end side of the rope-like body being connected to a movable part on the workpiece-receiving-part side, and the other end side of the rope-like body being fixed to a fixing part.

2. The workpiece support device for a workpiece rotation device, according to claim 1,
wherein the lifting/lowering operation part is an air cylinder having a lock function,
the distal end of the operation part is a rod distal end of an operation rod of the air cylinder, and
the control unit controls an operation of the air cylinder through a pressure regulating valve.

3. The workpiece support device for a workpiece rotation device, according to claim 1,
wherein the mounting base is connected to a moving end of a cable carrier which is laid in a movement direction of the mounting base.

4. The workpiece support device for a workpiece rotation device, according to claim 2, further comprising
a storage unit that pre-stores a relationship between information on the workpiece and self-weight deflection of the workpiece,
wherein the control unit controls a pressure of the air cylinder based on information obtained from the storage unit, indicating the relationship between the information on the workpiece and the self-weight deflection of the workpiece.

5. The workpiece support device for a workpiece rotation device, according to claim 4, further comprising:
a displacement sensor that detects a lifting position of the movable part; and
a rotation sensor that detects a rotation position of the positioners,
wherein the control unit calculates a target height of the workpiece-receiving part based on the rotation position of the workpiece obtained by the rotation sensor, and controls the pressure of the air cylinder based on the displacement sensor so that the workpiece-receiving part reaches the target height.

6. A workpiece rotation device comprising:
positioners that hold both end sides of a long workpiece, and rotate the workpiece about a rotational axis in a longitudinal direction; and one or a plurality of workpiece support devices that support a longitudinal middle part of the workpiece from below,
wherein the workpiece support devices each include:
a pair of lifting mechanisms;
a mounting base that movably supports the pair of lifting mechanisms in the longitudinal direction of the workpiece; and
a workpiece-receiving part provided to bridge between the pair of lifting mechanisms, and
the lifting mechanisms each include:
a lifting/lowering operation part in which an operation part moves vertically;
a control unit that controls an operating force of the lifting/lowering operation part;
a moving pulley part that is pivotally supported by a distal end of an operation part of the lifting/lowering operation part; and
a rope-like body that is wound around the moving pulley part, one end side of the rope-like body being connected to the workpiece-receiving-part side, and the other end side of the rope-like body being fixed to a fixing part.

7. The workpiece rotation device according to claim 6, further comprising:
a control unit that controls the positioners; and
a laser sensor that detects a distance to the workpiece support device,
wherein the workpiece support devices are provided with a reflection part that reflects a laser emitted from the laser sensor.
